(19) United States
(12) Patent Application Publication
(10) Pub. No.: US 2020/0110407 A1
(43) Pub. Date: Apr. 9, 2020

(54) NOTIFICATION SYSTEM, CONTROL METHOD THEREOF, VEHICLE, AND NON-TRANSITORY COMPUTER-READABLE MEDIUM

(71) Applicant: HONDA MOTOR CO., LTD., Tokyo (JP)

(72) Inventors: Hiroshi MIURA, Wako-shi (JP); Takafumi HIROSE, Wako-shi (JP)

(21) Appl. No.: 16/705,615

(22) Filed: Dec. 6, 2019

Related U.S. Application Data
(63) Continuation of application No. PCT/JP2017/023627, filed on Jun. 27, 2017.

(51) Int. Cl. G05D 1/00; G05D 1/02; G07C 5/08; B60S 1/56

(52) U.S. Cl. CPC G05D 1/0061; G05D 1/0088; B60S 1/56; G07C 5/0825; G07C 5/0833; G05D 1/0212

(57) ABSTRACT

A notification system in a vehicle that performs automated driving and includes a plurality of detection unit configured to acquire peripheral information, comprises: a specifying unit that specifies dirt of each of the plurality of detection units; an acquisition unit that acquires information of a scheduled traveling route; a determination unit that determines whether a range where automated driving is possible is included in the traveling route; and a notification unit that makes a notification of information concerning dirt specified for each of the plurality of detection units if it is determined by the determination unit that the range where automated driving is possible is included.

### CROSS-REFERENCE TO RELATED APPLICATION

This application is a continuation of International Patent Application No. PCT/JP2017/023627 filed on Jun. 27, 2017, the entire disclosures of which is incorporated herein by reference.

### TECHNICAL FIELD

The present invention relates to a notification system, a control method thereof, a vehicle, and a non-transitory computer-readable medium.

### BACKGROUND ART

Conventionally, a vehicle capable of performing automated driving is provided with a plurality of detection means (sensors and the like), and control concerning automated driving is performed based on the detection results of the detection means. Since the detection accuracy of the detection means lowers due to dirt derived from aging, the traveling environment, or the like, it is important to grasp the dirt situation of the detection means to appropriately execute control concerning automated driving.

PTL 1 describes that when an in-vehicle visual sensor is dirty, the driver is alarmed of it. Additionally, PTL 2 describes that adhesion of snow to an in-vehicle raindrop sensor is detected, and an alarm is made when the ignition is turned on. PTL 3 describes that a vehicle includes a camera as a detection means, and if a white line cannot be detected in an image captured by the camera, an alarm is made.

### CITATION LIST

### Patent Literature

PTL 1: Japanese Patent Laid-Open No. 07-093698

PTL 2: Japanese Patent Laid-Open No. 05-116595

PTL 3: Japanese Patent Laid-Open No. 2000-207563

### SUMMARY OF INVENTION

### Technical Problem

A vehicle supporting automated driving includes a plurality of detection means to acquire information on the periphery, and lowering of the detection accuracy of each detection means affects the stability and continuity of automated driving. On the other hand, if the user is notified of dirt or a request to remove it every time dirt is detected, the user feels troublesome, and as a result, usability lowers.

It is an object of the present invention to provide information concerning dirt of a detection means to a user at an appropriate timing to maintain the accuracy of an in-vehicle detection means.

### Solution to Problem

In order to solve the above-described problem, the present invention has the following arrangement. That is, there is provided a notification system in a vehicle that performs automated driving and includes a plurality of detection unit for acquiring peripheral information, comprising a specifying unit configured to specify dirt of each of the plurality of detection units, an acquisition unit configured to acquire information of a scheduled traveling route, a determination unit configured to determine whether a range where automated driving is possible is included in the traveling route, and a notification unit configured to make a notification of information concerning dirt specified for each of the plurality of detection units if it is determined by the determination unit that the range where automated driving is possible is included.

### Advantageous Effects of Invention

According to the present invention, it is possible to provide information concerning dirt of a detection means to a user at an appropriate timing while maintaining the accuracy of the detection means required for automated driving.

Other features and advantages of the present invention will be apparent from the following descriptions taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram of a vehicle control system according to an embodiment of the present invention;

FIG. 2 is a block diagram of the vehicle control system according to an embodiment of the present invention;

FIG. 3 is a block diagram of the vehicle control system according to an embodiment of the present invention;

FIG. 4A is a view for explaining an example of offset traveling according to an embodiment of the present invention;

FIG. 4B is a view for explaining an example of offset traveling according to an embodiment of the present invention;

FIG. 5 is a flowchart of dirt notification processing according to the first embodiment of the present invention;

FIG. 6A is a flowchart of automated driving propriety control processing according to the first embodiment of the present invention;

FIG. 6B is a flowchart of automated driving propriety control processing according to the first embodiment of the present invention;

FIG. 7 is a view showing an example of the arrangement of a table used in dirt notification according to the first embodiment of the present invention;

FIG. 8 is a view showing an example of the arrangement of a screen used in dirt notification according to the first embodiment of the present invention;

FIG. 9 is a flowchart of dirt notification processing according to the second embodiment of the present invention;

FIG. 10 is a flowchart of dirt notification processing according to the third embodiment of the present invention;

FIG. 11A is a flowchart of dirt notification processing according to the fourth embodiment of the present invention;

FIG. 11B is a flowchart of dirt notification processing according to the fourth embodiment of the present invention; and

FIG. 12 is a view showing an example of the arrangement of a table used in dirt notification according to the fourth embodiment of the present invention.

### DESCRIPTION OF EMBODIMENTS

An embodiment of the present invention will now be described with reference to the accompanying drawings. Note that the arrangement and the like to be described below are merely examples, and are not limited to those.

An example of the arrangement of a control system of a vehicle concerning automated driving to which the present invention can be applied will be described first.

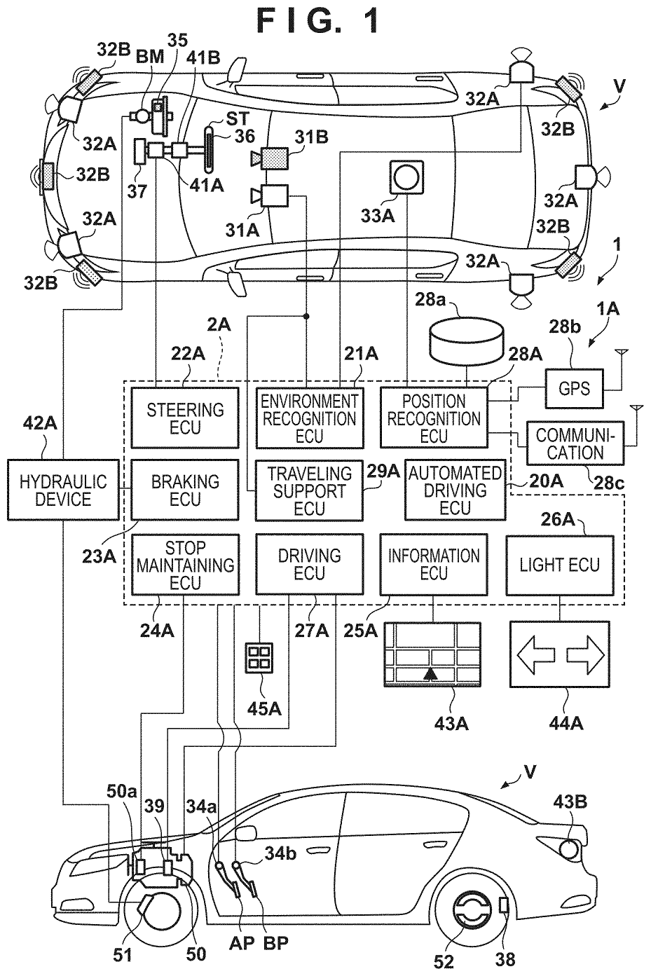

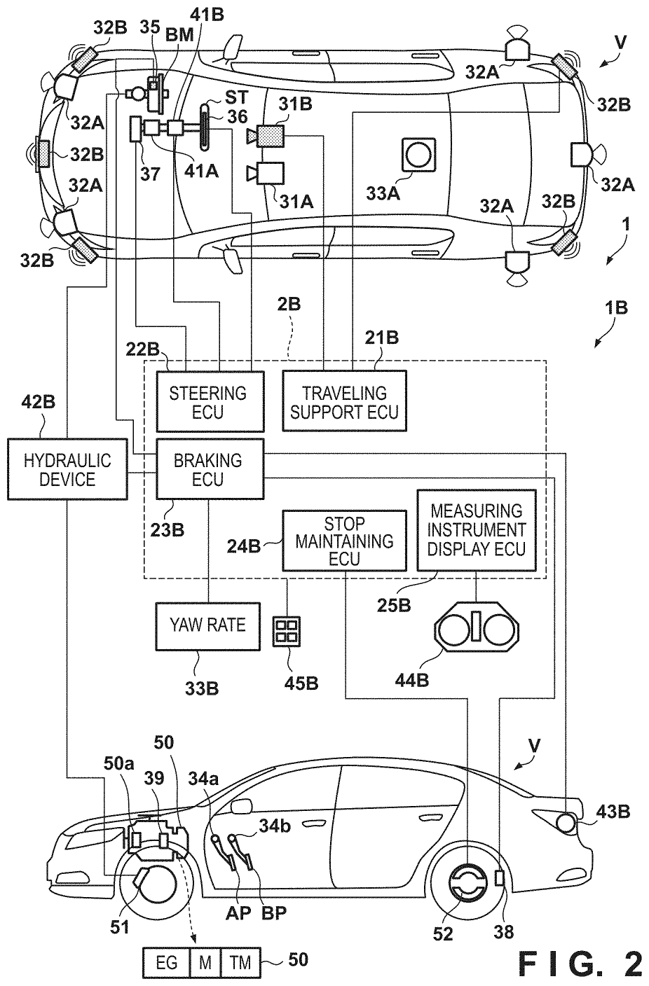

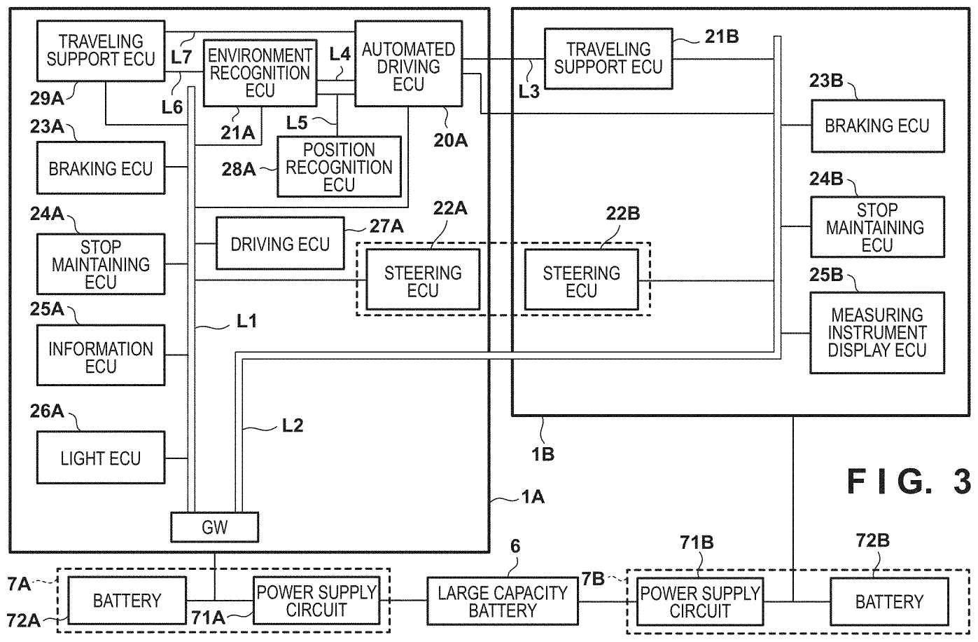

FIGS. 1 to 3 are block diagrams of a vehicle control system 1 according to an embodiment of the present invention. The control system 1 controls a vehicle V. In each of FIGS. 1 and 2, an outline of the vehicle V is shown in a plan view and a side view. As an example, the vehicle V is a sedan-type four-wheeled vehicle. The control system 1 includes a control apparatus 1A and a control apparatus 1B. FIG. 1 is a block diagram showing the control apparatus 1A, and FIG. 2 is a block diagram showing the control apparatus 1B. FIG. 3 mainly shows the arrangement of communication lines between the control apparatus 1A and the control apparatus 1B and power supplies.

The control apparatus 1A and the control apparatus 1B make some functions implemented by the vehicle V multiplexed or redundant. This can improve the reliability of the system. The control apparatus 1A performs, for example, not only automated driving control and normal operation control in manual driving but also traveling support control concerning risk avoidance and the like. The control apparatus 1B mainly performs traveling support control concerning risk avoidance and the like. Traveling support will sometimes be referred to as driving support. The control apparatus 1A and the control apparatus 1B are caused to perform different control processes while making the functions redundant, thereby improving the reliability while distributing the control processes.

The vehicle V according to this embodiment is a parallel hybrid vehicle. FIG. 2 schematically shows the arrangement of a power plant 50 that outputs a driving force to rotate the driving wheels of the vehicle V. The power plant 50 includes an internal combustion engine EG, a motor M, and an automatic transmission TM. The motor M is usable as a driving source to accelerate the vehicle V and is also usable as a power generator upon deceleration or the like (regenerative braking).

<Control Apparatus 1A>

The arrangement of the control apparatus 1A will be described with reference to FIG. 1. The control apparatus 1A includes an ECU group (control unit group) 2A. The ECU group 2A includes a plurality of ECUs 20A to 29A. Each ECU includes a processor represented by a CPU (Central Processing Unit), a storage device such as a semiconductor memory, an interface with an external device, and the like. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIGS. 1 and 3, the names of the representative functions of the ECUs 20A to 29A are given. For example, the ECU 20A is denoted by “automated driving ECU”.

The ECU 20A executes control associated with automated driving as traveling control of the vehicle V. In automated driving, at least one of driving (acceleration of the vehicle V by the power plant 50, and the like), steering, and braking of the vehicle V is automatically performed independently of the driving operation of the driver. In this embodiment, driving, steering, and braking are automatically performed.

The ECU 21A is an environment recognition unit configured to recognize the traveling environment of the vehicle V based on the detection results of detection units 31A and 32A that detect the peripheral situation of the vehicle V. The ECU 21A generates target data (to be described later) as peripheral environment information.

In this embodiment, the detection unit 31A is an image capturing device (to be sometimes referred to as the camera 31A hereinafter) configured to detect an object around the vehicle V by image capturing. The camera 31A is provided at the roof front of the vehicle V to capture the front side of the vehicle V. When images captured by the camera 31A are analyzed, the contour of a target or a division line (a white line or the like) of a lane on a road can be extracted.

In this embodiment, the detection unit 32A is a lidar (laser radar) (to be sometimes referred to as the lidar 32A hereinafter) configured to detect an object around the vehicle V by light, and detects a target around the vehicle V or measures the distance to a target. In this embodiment, five lidars 32A are provided; one at each corner of the front portion of the vehicle V, one at the center of the rear portion, and one on each side of the rear portion. The number of lidars 32A and their arrangement can appropriately be selected.

The ECU 29A is a traveling support unit configured to execute control associated with traveling support (in other words, driving support) as traveling control of the vehicle V based on the detection result of the detection unit 31A.

The ECU 22A is a steering control unit configured to control an electric power steering device 41A. The electric power steering device 41A includes a mechanism that steers the front wheels in accordance with the driving operation (steering operation) of the driver on a steering wheel ST. The electric power steering device 41A includes a motor that generates a driving force to assist the steering operation or automatically steer the front wheels, a sensor that detects the rotation amount of the motor, a torque sensor that detects the steering torque on the driver, and the like.

The ECU 23A is a braking control unit configured to control a hydraulic device 42A. A braking operation of the driver on a brake pedal BP is converted into a fluid pressure by a brake master cylinder BM and transmitted to the hydraulic device 42A. The hydraulic device 42A is an actuator capable of controlling, based on the fluid pressure transmitted from the brake master cylinder BM, the fluid pressure of hydraulic oil to be supplied to a brake device (for example, a disc brake device) 51 provided in each of the four wheels. The ECU 23A performs driving control of a solenoid valve and the like provided in the hydraulic device 42A. In this embodiment, the ECU 23A and the hydraulic device 42A form an electric servo brake. The ECU 23A controls, for example, the distribution of a braking force by the four brake devices 51 and a braking force by regenerative braking of the motor M.

The ECU 24A is a stop maintaining control unit configured to control an electric parking lock device 50a provided in the automatic transmission TM. The electric parking lock device 50a includes a mechanism that mainly locks the internal mechanism of the automatic transmission TM when the P range (parking range) is selected. The ECU 24A can control lock and unlock by the electric parking lock device 50a.

The ECU 25A is an in-vehicle alarm control unit configured to control an information output device 43A that alarms information in the vehicle. The information output device 43A includes, for example, a display device such as a head-up display and a voice output device. The information output device 43A may further include a vibration device. The ECU 25A causes the information output device 43A to output, for example, various kinds of information such as a vehicle speed and an atmospheric temperature and information such as a path guidance.

The ECU 26A is an external alarm control unit configured to control an information output device 44A that alarms information outside the vehicle. In this embodiment, the information output device 44A is a direction indicator (hazard lamp). The ECU 26A controls blinking of the information output device 44A serving as a direction indicator, thereby alarming the exterior of the vehicle of the advancing direction of the vehicle V. In addition, the ECU 26A controls blinking of the information output device 44A serving as a hazard lamp, thereby increasing the attention of the exterior to the vehicle V.

The ECU 27A is a driving control unit configured to control the power plant 50. In this embodiment, one ECU 27A is assigned to the power plant 50. However, one ECU may be assigned to each of the internal combustion engine EG, the motor M, and the automatic transmission TM. The ECU 27A controls the output of the internal combustion engine EG or the motor M or switches the gear range of the automatic transmission TM in correspondence with, for example, the driving operation of the driver detected by an operation detection sensor 34a provided on an accelerator pedal AP or an operation detection sensor 34b provided on the brake pedal BP, the vehicle speed, or the like. Note that as a sensor that detects the traveling state of the vehicle V, a rotation speed sensor 39 that detects the rotation speed of the output shaft of the automatic transmission TM is provided in the automatic transmission TM. The vehicle speed of the vehicle V can be calculated from the detection result of the rotation speed sensor 39.

The ECU 28A is a position recognition unit configured to recognize the current position or the route of the vehicle V. The ECU 28A performs control of a gyro sensor 33A, a GPS sensor 28b, and a communication device 28c and information processing of a detection result or a communication result. The gyro sensor 33A detects the rotary motion of the vehicle V. The route of the vehicle V can be determined based on the detection result of the gyro sensor 33A, and the like. The GPS sensor 28b detects the current position of the vehicle V. The communication device 28c performs wireless communication with a server configured to provide map information and traffic information, and acquires these pieces of information. A database 28a can store accurate map information. The ECU 28A can more accurately specify the position of the vehicle V on a lane based on the map information and the like.

An input device 45A is arranged in the vehicle such that the driver can operate it, and accepts input of an instruction or information from the driver.

<Control Apparatus 1B>

The arrangement of the control apparatus 1B will be described with reference to FIG. 2. The control apparatus 1B includes an ECU group (control unit group) 2B. The ECU group 2B includes a plurality of ECUs 21B to 25B. Each ECU includes a processor represented by a CPU, a storage device such as a semiconductor memory, an interface with an external device, and the like. The storage device stores programs to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment. Note that in FIGS. 2 and 3, the names of the representative functions of the ECUs 21B to 25B are given, like the ECU group 2A.

The ECU 21B is an environment recognition unit configured to recognize the traveling environment of the vehicle V based on the detection results of detection units 31B and 32B that detect the peripheral situation of the vehicle V, and also serves as a traveling support unit configured to execute control associated with traveling support (in other words, driving support) as traveling control of the vehicle V. The ECU 21B generates target data (to be described later) as peripheral environment information.

Note that in this embodiment, the ECU 21B has the environment recognition function and the traveling support function. However, an ECU may be provided for each function, like the ECU 21A and the ECU 29A of the control apparatus 1A. Reversely, in the control apparatus 1A, the functions of the ECU 21A and the ECU 29A may be implemented be one ECU, like the ECU 21B.

In this embodiment, the detection unit 31B is an image capturing device (to be sometimes referred to as the camera 31B hereinafter) configured to detect an object around the vehicle V by image capturing. The camera 31B is provided at the roof front of the vehicle V to capture the front side of the vehicle V. When images captured by the camera 31B are analyzed, the contour of a target or a division line (a white line or the like) of a lane on a road can be extracted. In this embodiment, the detection unit 32B is a millimeter wave radar (to be sometimes referred to as the radar 32B hereinafter) configured to detect an object around the vehicle V by a radio wave, and detects a target around the vehicle V or measures the distance to a target. In this embodiment, five radars 32B are provided; one at the center of the front portion of the vehicle V, one at each corner of the front portion, and one at each corner of the rear portion. The number of radars 32B and their arrangement can appropriately be selected.

The ECU 22B is a steering control unit configured to control the electric power steering device 41B. The electric power steering device 41B includes a mechanism that steers the front wheels in accordance with the driving operation (steering operation) of the driver on the steering wheel ST. The electric power steering device 41B includes a motor that generates a driving force to assist the steering operation or automatically steer the front wheels, a sensor that detects the rotation amount of the motor, a torque sensor that detects the steering torque on the driver, and the like. In addition, a steering angle sensor 37 is electrically connected to the ECU 22B via a communication line L2 to be described later, and the electric power steering device 41B can be controlled based on the detection result of the steering angle sensor 37. The ECU 22B can acquire the detection result of a sensor 36 that detects whether the driver is gripping the steering handle ST, and can monitor the gripping state of the driver.

The ECU 23B is a braking control unit configured to control a hydraulic device 42B. A braking operation of the driver on the brake pedal BP is converted into a fluid pressure by the brake master cylinder BM and transmitted to the hydraulic device 42B. The hydraulic device 42B is an actuator capable of controlling, based on the fluid pressure transmitted from the brake master cylinder BM, the fluid pressure of hydraulic oil to be supplied to the brake device 51 of each wheel. The ECU 23B performs driving control of a solenoid valve and the like provided in the hydraulic device 42B.

In this embodiment, a wheel speed sensor 38 provided in each of the four wheels, a yaw rate sensor 33B, and a pressure sensor 35 configured to detect the pressure in the brake master cylinder BM are electrically connected to the ECU 23B and the hydraulic device 42B, and based on the detection results of these, an ABS function, traction control, and the posture control function for the vehicle V are implemented. For example, the ECU 23B adjusts the braking force of each wheel based on the detection result of the wheel speed sensor 38 provided in each of the four wheels, thereby suppressing skid of each wheel. In addition, the ECU 23B adjusts the braking force of each wheel based on the rotation angular speed about the vertical axis of the vehicle V detected by the yaw rate sensor 33B, thereby suppressing an abrupt posture change of the vehicle V.

The ECU 23B also functions as an external alarm control unit configured to control an information output device 43B that alarms information outside the vehicle. In this embodiment, the information output device 43B is a brake lamp, and the ECU 23B can light the brake lamp at the time of braking or the like. This can increase the attention of a following vehicle to the vehicle V.

The ECU 24B is a stop maintaining control unit configured to control an electric parking brake device (for example, a drum brake) 52 provided in each rear wheel. The electric parking brake device 52 includes a mechanism that locks the rear wheel. The ECU 24B can control lock and unlock of the rear wheels by the electric parking brake devices 52.

The ECU 25B is an in-vehicle alarm control unit configured to control an information output device 44B that alarms information in the vehicle. In this embodiment, the information output device 44B includes a display device arranged on the instrument panel. The ECU 25B can cause the information output device 44B to output various kinds of information such as a vehicle speed and fuel consumption.

An input device 45B is arranged in the vehicle such that the driver can operate it, and accepts input of an instruction or information from the driver.

<Communication Lines>

An example of communication lines of the control system 1, which communicably connect the ECUs, will be described with reference to FIG. 3. The control system 1 includes communication lines L1 to L7 of wired communication. The ECUs 20A to 27A and 29A of the control apparatus 1A are connected to the communication line L1. Note that the ECU 28A may also be connected to the communication line L1.

The ECUs 21B to 25B of the control apparatus 1B are connected to the communication line L2. The ECU 20A of the control apparatus 1A is also connected to the communication line L2. The communication line L3 connects the ECU 20A and the ECU 21B. The communication line L5 connects the ECU 20A, the ECU 21A, and the ECU 28A. The communication line L6 connects the ECU 29A and the ECU 21A. The communication line L7 connects the ECU 29A and the ECU 20A.

The protocols of the communication lines L1 to L7 may be identical or different, and may be changed in accordance with the communication environment such as a communication speed, a communication amount, and durability. For example, the communication lines L3 and L4 may be Ethernet® from the viewpoint of communication speed. For example, the communication lines L1, L2, and L5 to L7 may be CAN.

The control apparatus 1A includes a gateway GW. The gateway GW relays the communication line L1 and the communication line L2. For this reason, for example, the ECU 21B can output a control instruction to the ECU 27A via the communication line L2, the gateway GW, and the communication line L1.

<Power Supply>

The power supply of the control system 1 will be described with reference to FIG. 3. The control system 1 includes a large capacity battery 6, a power supply 7A, and a power supply 7B. The large capacity battery 6 is a battery used to drive the motor M and charged by the motor M.

The power supply 7A is a power supply that supplies power to the control apparatus 1A, and includes a power supply circuit 71A and a battery 72A. The power supply circuit 71A is a circuit that supplies the power of the large capacity battery 6 to the control apparatus 1A, and, for example, lowers the output voltage (for example, 190 V) of the large capacity battery 6 to a reference voltage (for example, 12 V). The battery 72A is a lead battery of, for example, 12 V. Since the battery 72A is provided, the power can be supplied to the control apparatus 1A even in a case in which the power supply of the large capacity battery 6 or the power supply circuit 71A is shut down or lowers.

The power supply 7B is a power supply that supplies power to the control apparatus 1B, and includes a power supply circuit 71B and a battery 72B. The power supply circuit 71B is a circuit that is similar to the power supply circuit 71A and supplies the power of the large capacity battery 6 to the control apparatus 1B. The battery 72B is a battery similar to the battery 72A, and is a lead battery of, for example, 12 V. Since the battery 72B is provided, the power can be supplied to the control apparatus 1B even in a case in which the power supply of the large capacity battery 6 or the power supply circuit 71B is shut down or lowers.

<Redundancy>

Functions common to the control apparatus 1A and the control apparatus 1B will be described. When the same functions are made redundant, the reliability of the control system 1 can be improved. In addition, some redundant functions provide different functions, instead of multiplexing the same functions. This suppresses an increase in cost caused by the redundancy of functions.

[Actuator System]

Steering

The control apparatus 1A includes the electric power steering device 41A and the ECU 22A that controls this. The control apparatus 1B also includes the electric power steering device 41B and the ECU 22B that controls this.

Braking

The control apparatus 1A includes the hydraulic device 42A and the ECU 23A that controls this. The control apparatus 1B includes the hydraulic device 42B and the ECU 23B that controls this. All of these can be used for braking of the vehicle V. On the other hand, the main function of the braking mechanism of the control apparatus 1A is the distribution of the braking force by the brake device 51 and the braking force by the regenerative braking of the motor M. On the other hand, the main function of the braking mechanism of the control apparatus 1B is posture control and the like. Although the functions are common concerning braking, functions different from each other are provided.

Stop Maintaining

The control apparatus 1A includes the electric parking lock device 50a and the ECU 24A that controls this. The control apparatus 1B includes the electric parking brake device 52 and the ECU 24B that controls this. All of these can be used to maintain the stop of the vehicle V. On the other hand, although the electric parking lock device 50a is a device that functions when the P range of the automatic transmission TM is selected, the electric parking brake device 52 is a device that locks a rear wheel. Although the functions are common concerning stop maintaining of the vehicle V, functions different from each other are provided.

In-Vehicle Alarm

The control apparatus 1A includes the information output device 43A and the ECU 25A that controls this. The control apparatus 1B includes the information output device 44B and the ECU 25B that controls this. All of these can be used to alarm the driver of information. On the other hand, the information output device 43A is, for example, a head-up display, and the information output device 44B is a display device such as a measuring instrument. Although the functions are common concerning in-vehicle alarm, display devices different from each other can be employed.

External Alarm

The control apparatus 1A includes the information output device 44A and the ECU 26A that controls this. The control apparatus 1B includes the information output device 43B and the ECU 23B that controls this. All of these can be used to alarm information outside the vehicle. On the other hand, the information output device 44A is a direction indicator (hazard lamp), and the information output device 43B is a brake lamp. Although the functions are common concerning external alarm, functions different from each other are provided.

Different Points

The control apparatus 1A includes the ECU 27A that controls the power plant 50. However, the control apparatus 1B does not include a unique ECU that controls the power plant 50. In this embodiment, both the control apparatuses 1A and 1B can solely perform steering, braking, and stop maintaining. Hence, even if the control apparatus 1A or control apparatus 1B suffers performance degradation, power supply shutdown, or communication interruption, it is possible to decelerate and maintain the stop state while suppressing lane departure. Additionally, as described above, the ECU 21B can output a control instruction to the ECU 27A via the communication line L2, the gateway GW, and the communication line L1, and the ECU 21B can also control the power plant 50. Since the control apparatus 1B does not include a unique ECU that controls the power plant 50, an increase in cost can be suppressed. However, the control apparatus 1B may include a unique ECU.

[Sensor System]

Detection of Peripheral Situation

The control apparatus 1A includes the detection units 31A and 32A. The control apparatus 1B includes the detection units 31B and 32B. All of these can be used to recognize the traveling environment of the vehicle V. On the other hand, the detection unit 32A is a lidar, and the detection unit 32B is a radar. The lidar is generally advantageous in detecting a shape. Additionally, the radar is generally more advantageous than the lidar from the viewpoint of cost. When these sensors of different characteristics are used, it is possible to improve target recognition performance and reduce the cost. Both the detection units 31A and 31B are cameras. Cameras of different characteristics may be used. For example, one of them may be a camera of a resolution higher than the other. In addition, the angles of view may be different from each other.

As for comparison of the control apparatus 1A and the control apparatus 1B, the detection characteristics of the detection units 31A and 32A may be different from those of the detection units 31B and 32B. In this embodiment, the detection unit 32A is a lidar whose target edge detection performance is higher than that of the radar (detection unit 32B) in general. Additionally, the radar is generally excellent in the relative speed detection accuracy or weatherability as compared to the lidar.

In addition, if the camera 31A has a resolution higher than that of the camera 31B, the detection performance of the detection units 31A and 32A is higher than that of the detection units 31B and 32B. When the plurality of sensors of different detection characteristics and costs are combined, cost advantage can sometimes be obtained in the whole system. In addition, when the sensors of different detection characteristics are combined, detection omission or detection errors can be reduced as compared to a case in which redundancy is attained by identical sensors.

Vehicle Speed

The control apparatus 1A includes the rotation speed sensor 39. The control apparatus 1B includes the wheel speed sensor 38. Both can be used to detect the vehicle speed. On the other hand, the rotation speed sensor 39 detects the rotation speed of the output shaft of the automatic transmission TM, and the wheel speed sensor 38 detects the rotation speed of the wheels. Although the sensors are common concerning the capability of detecting the vehicle speed, the detection targets are different from each other.

Yaw Rate

The control apparatus 1A includes the gyro sensor 33A. The control apparatus 1B includes the yaw rate sensor 33B. Both can be used to detect the angular velocity about the vertical axis of the vehicle V. On the other hand, the gyro sensor 33A is used to determine the route of the vehicle V, and the yaw rate sensor 33B is used for posture control of the vehicle V, and the like. Although the sensors are common concerning the capability of detecting the angular velocity of the vehicle V, the use purposes are different from each other.

Steering Angle and Steering Torque

The control apparatus 1A includes a sensor that detects the rotation amount of the motor of the electric power steering device 41A. The control apparatus 1B includes the steering angle sensor 37. Both can be used to detect the steering angle of the front wheels. In the control apparatus 1A, an increase in cost can be suppressed by using the sensor that detects the rotation amount of the motor of the electric power steering device 41A, instead of additionally providing the steering angle sensor 37. However, the steering angle sensor 37 may additionally be provided in the control apparatus 1A.

In addition, when both the electric power steering devices 41A and 41B include torque sensors, the steering torque can be recognized in both the control apparatuses 1A and 1B.

Braking Operation Amount

The control apparatus 1A includes the operation detection sensor 34b. The control apparatus 1B includes the pressure sensor 35. Both can be used to detect the braking operation amount of the driver. On the other hand, the operation detection sensor 34b is used to control the distribution of the braking force by the four brake devices 51 and the braking force by regenerative braking of the motor M, and the pressure sensor 35 is used for posture control and the like. Although the sensors are common concerning detection of the braking operation amount, the use purposes are different from each other.

[Power Supply]

The control apparatus 1A receives power supply from the power supply 7A, and the control apparatus 1B receives power supply from the power supply 7B. Since the power is supplied to any one of the control apparatuses 1A and 1B even in a case in which the power supply of one of the power supply 7A and the power supply 7B is shut down or lowers, it is possible to more reliably ensure the power supply and improve the reliability of the control system 1. If the power supply of the power supply 7A is shut down or lowers, it is difficult to perform communication between the ECUs via the gateway GW provided in the control apparatus 1A. However, in the control apparatus 1B, the ECU 21B can communicate with the ECUs 22B to 24B and 44B via the communication line L2.

[Redundancy in Control Apparatus 1A]

The control apparatus 1A includes the ECU 20A that performs automated driving control, and the ECU 29A that performs traveling support control. That is, the control apparatus 1A includes two control units configured to perform traveling control.

<Examples of Control Functions>

Control functions executable by the control apparatus 1A or 1B include traveling-associated functions associated with control of driving, braking, and steering of the vehicle V, and alarm functions associated with an alarm of information to the driver.

Examples of traveling-associated functions are lane maintaining control, lane departure suppression control (lane deviation suppression control), lane change control, preceding vehicle following control, collision reduction brake control, and erroneous start suppression control. Examples of the alarm functions are adjacent vehicle alarm control and preceding vehicle start alarm control.

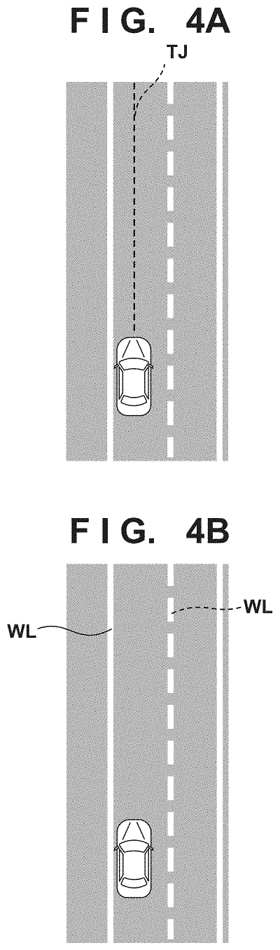

Lane maintaining control is one of control processes for the position of the vehicle with respect to a lane. This control makes the vehicle travel automatically (without depending on the driving operation of the driver) on a traveling track TJ set in a lane, as schematically shown in FIG. 4A. Lane departure suppression control is one of control processes for the position of the vehicle with respect to a lane. As schematically shown in FIG. 4B, a white line or a median strip WL is detected, and steering is automatically performed so the vehicle does not pass across the line WL. As described above, lane departure suppression control and lane maintaining control are different functions.

Lane change control is control of automatically moving the vehicle from the lane on which the vehicle is traveling to an adjacent lane. Preceding vehicle following control is control of automatically following another vehicle traveling ahead of the self-vehicle. Collision reduction brake control is control of automatically braking the vehicle and supporting collision avoidance in a case in which the possibility of collision against an obstacle ahead of the vehicle rises. Erroneous start suppression control is control of limiting acceleration of the vehicle in a vehicle stop state in a case in which the acceleration operation by the driver is a predetermined amount or more, and suppresses abrupt start.

Adjacent vehicle alarm control is control of alarming the driver of the presence of another vehicle traveling on the adjacent lane adjacent to the traveling lane of the self-vehicle. The driver is alarmed of, for example, the presence of another vehicle traveling on a side or on a rear side of the self-vehicle. Preceding vehicle start alarm control is control of alarming that the self-vehicle and another vehicle ahead are in a stop state, and another vehicle ahead has started. These alarms can be made by the above-described in-vehicle alarm devices (the information output device 43A and the information output device 44B).

The ECU 20A, the ECU 29A, and the ECU 21B can share and execute these functions. Which control function is to be assigned to which ECU can appropriately be selected.

### First Embodiment

Control according to the present invention will be described below. As described above, a vehicle according to an embodiment of the present invention includes a plurality of detection means, and a plurality of types of detection means are provided in accordance with the detection target or the like. A description will be made here assuming that dirt is generated in each of the detection means due to some reasons, and the detection accuracy is lowered by the dirt although the degree or frequency of dirt changes depending on the mounting position, the traveling situation, the structure, and the like. In addition, “dirt” on a detection means is not particularly limited. Dirt lowers the detection accuracy of a detection means by an external factor or the like and can be removed here by a cleaning action by the user or the like. A detection means that is affected by dirt will be referred to as a sensor hereinafter.

<Control Procedure>

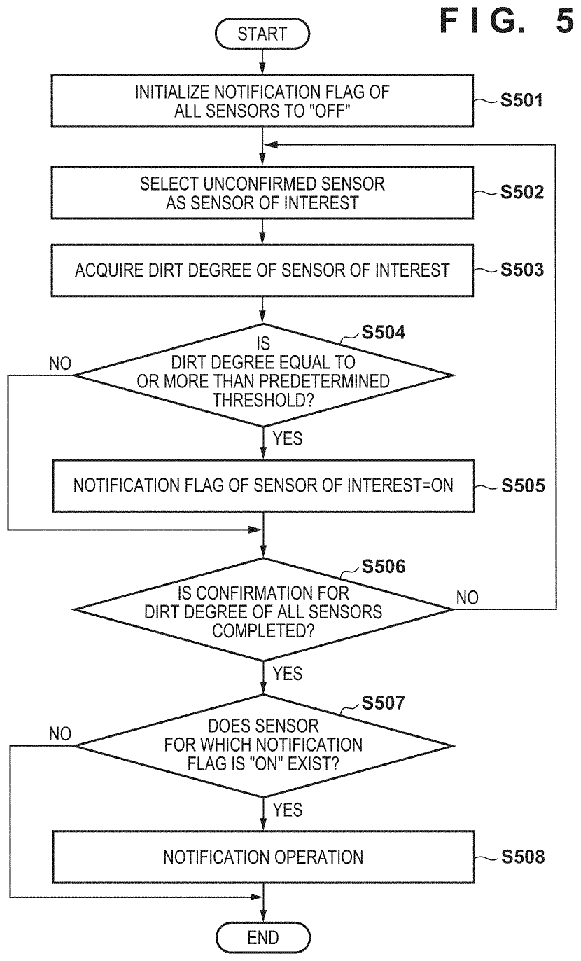

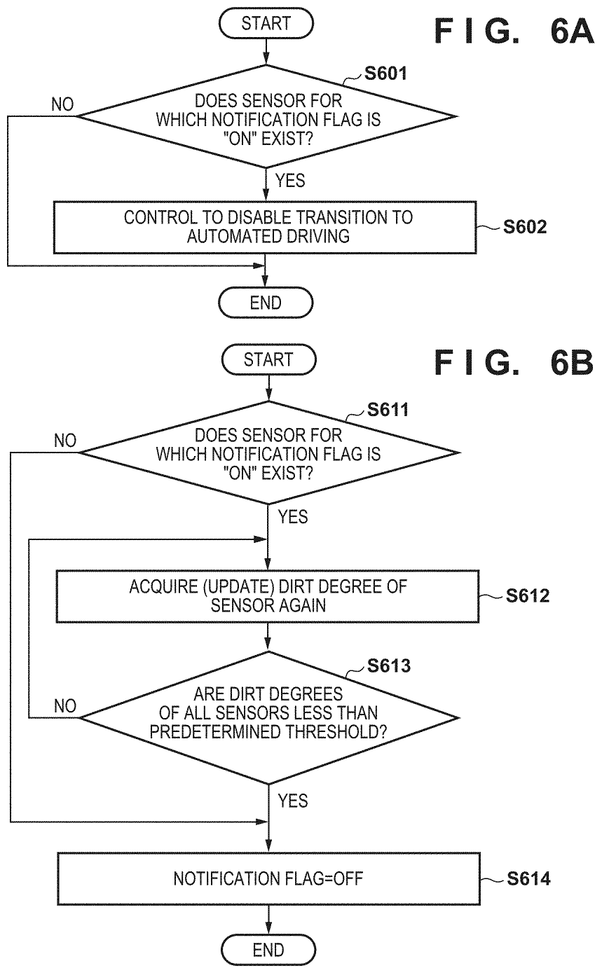

A control procedure according to this embodiment will be described with reference to FIGS. 5, 6A, and 6B. Note that this processing is implemented when the ECUs execute a predetermined program and cooperate with the above-described control units. Note that the control to be described below is not limited to control by one of the control apparatuses 1A and 1B, and an explanation will be made here by comprehensively describing the subject of processing as a control apparatus 1.

(Dirt Notification Processing)

Dirt notification processing of detecting dirt on a plurality of sensors according to this embodiment and notifying it will be described with reference to FIG. 5.

In step S501, the control apparatus 1 initializes all notification flags corresponding to the plurality of sensors, respectively, provided in the vehicle to “OFF”. Here, assume that the notification flags corresponding to the sensors are managed in a storage unit. In addition, if the value of a notification flag is “OFF”, it means that dirt on the corresponding sensor is within an allowable range, and a notification concerning the dirt is unnecessary. On the other hand, if the value of a notification flag is “ON”, it means that dirt on the corresponding sensor is out of the allowable range, and a notification concerning the dirt and removal of the dirt are necessary.

In step S502, the control apparatus 1 selects an undetermined sensor of the plurality of sensors as a sensor of interest.

In step S503, the control apparatus 1 acquires the dirt degree of the sensor of interest. As for the dirt degree here, the degree is defined in accordance with the type and structure of the sensor and is not particularly limited. In addition, a dirt degree specifying method is not particularly limited. For example, the dirt degree may be obtained from the ratio of a non-detection region to a detection region, or may be obtained from the reflectance of the detection region. If the sensor is a camera, the dirt degree may be specified based on a detection result of a region corresponding to dirt in an image.

In step S504, the control apparatus 1 determines whether the dirt degree acquired in step S503 is equal to or more than a predetermined threshold. The predetermined threshold here may be provided in accordance with the type, the installation position, and the like of a sensor. For example, all of the plurality of in-vehicle sensors may use different thresholds. The threshold here is defined in advance and held in the storage unit. If it is determined that the dirt degree of the sensor of interest is equal to or more than the predetermined threshold (YES in step S504), the process advances to step S505. If it is determined that the dirt degree of the sensor of interest is less than the predetermined threshold (NO in step S504), the process advances to step S506.

In step S505, the control apparatus 1 sets the value of the notification flag of the sensor of interest to “ON”.

In step S506, the control apparatus 1 determines whether the dirt degrees of all sensors are confirmed. If the confirmation is completed for all sensors (YES in step S506), the process advances to step S507. If an unconfirmed sensor exists (NO in step S506), the process returns to step S502 to repeat the processing by setting the unconfirmed sensor to the sensor of interest. Note that all of the plurality of sensors may be confirmed simultaneously (in parallel), or the detection order (priority) may be set in advance and confirmation may be done in the order. Alternatively, the sensors may be confirmed in the descending order of importance based on a predetermined reference. Important sensors here are, for example, a sensor formed from a camera and a sensor configured to detect the front side in the advancing direction.

In step S507, the control apparatus 1 determines whether a sensor for which the value of the notification flag is “ON” exists among all the sensors. If a sensor for which the value of the notification flag is “ON” exists (YES in step S507), the process advances to step S508. If the value of the notification flag is “OFF” for all the sensors (NO in step S507), the processing procedure is ended.

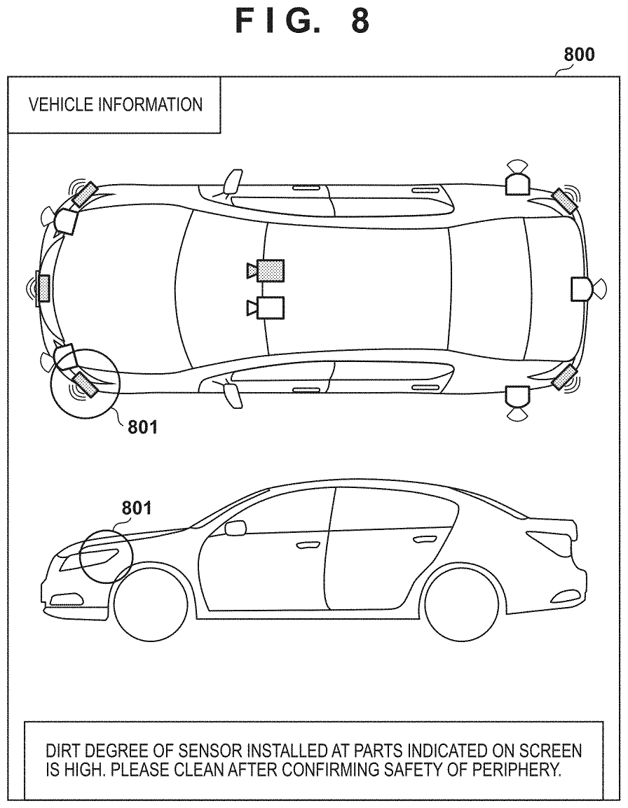

In step S508, the control apparatus 1 makes a notification of removal of dirt concerning a sensor for which the value of the notification flag is “ON”. A notification method here is not particularly limited. For example, an alarming means (not shown) provided on the periphery of a target sensor may be turned on, or the information of a sensor with a high dirt degree may be displayed on a predetermined display unit. In addition, information concerning the degree of dirt may be notified. An example of a screen will be described later with reference to FIG. 8. The processing procedure is then ended.

Note that the execution timing of the processing shown in FIG. 5 or the notification timing in the process of step S508 is defined in advance. As described above, if the notification operation is performed every time dirt is detected, usability lowers. The frequency of the notification can be limited by limiting the timing of executing the entire procedure shown in FIG. 5 to a predetermined timing or by limiting the timing of executing the process of step S508 to a predetermined timing. Note that the predetermined timing here is not particularly limited, and may be, for example, the timing of turning ignition on or the first driving timing after traveling is not performed for a long time.

(Automated Driving Propriety Control Processing)

Processing concerning automated driving propriety using the notification flag set based on the dirt degree according to this embodiment will be described with reference to FIGS. 6A and 6B. If the degree of dirt on each sensor is high, automated driving cannot stably be performed. In this processing, control based on a notification flag set in accordance with a degree of dirt is performed. Following processing is performed based on the notification flag set by the processing shown in FIG. 5.

Note that the timing of starting the processing may be, for example, the timing of the occurrence of an event such as engine start by the user, or the processing may be performed at a predetermined time interval. Processing shown in FIG. 6A will be described first.

In step S601, the control apparatus 1 determines whether a sensor for which the value of the notification flag is “ON” exists among all the sensors. If a sensor for which the value of the notification flag is “ON” exists (YES in step S601), the process advances to step S602. If the value of the notification flag is “OFF” for all the sensors (NO in step S601), the processing procedure is ended.

In step S602, the control apparatus 1 performs control to disable transition to automated driving. As for the control here, control may be performed not to accept an instruction of transition to automated driving, or a notification representing that automated driving cannot be executed may be made. The processing procedure is then ended.

Processing shown in FIG. 6B will be described next.

In step S611, the control apparatus 1 determines whether a sensor for which the value of the notification flag is “ON” exists among all the sensors. If a sensor for which the value of the notification flag is “ON” exists (YES in step S611), the process advances to step S612. If the value of the notification flag is “OFF” for all the sensors (NO in step S611), the processing procedure is ended.

In step S612, the control apparatus 1 acquires (updates) the dirt degree of each sensor again. The dirt degree acquisition method here is similar to that in the process of step S503 in FIG. 5. Note that here, the dirt degrees of only sensors for which the value of the notification flag is “ON” may be acquired, or the dirt degrees of all the sensors may be acquired.

In step S613, the control apparatus 1 determines whether the dirt degrees of all the sensors are less than predetermined thresholds corresponding to the sensors. As the threshold here, the same threshold as in step S504 in FIG. 5 is used. If it is determined that the dirt degrees of all the sensor are less than the predetermined thresholds (YES in step S613), the process advances to step S614. If it is determined that the dirt degree of at least one sensor is equal to or more than the predetermined threshold (NO in step S613), the process returns to step S612 to repeat the process. Note that in a case in which the process of step S612 is repeated, the process of step S612 may be performed after a predetermined period has elapsed from the previous information acquisition in consideration of the time of a dirt removal operation by the user.

In step S614, the control apparatus 1 sets the value of the notification flag of each sensor to “OFF”. The processing procedure is then ended.

(Example of Table)

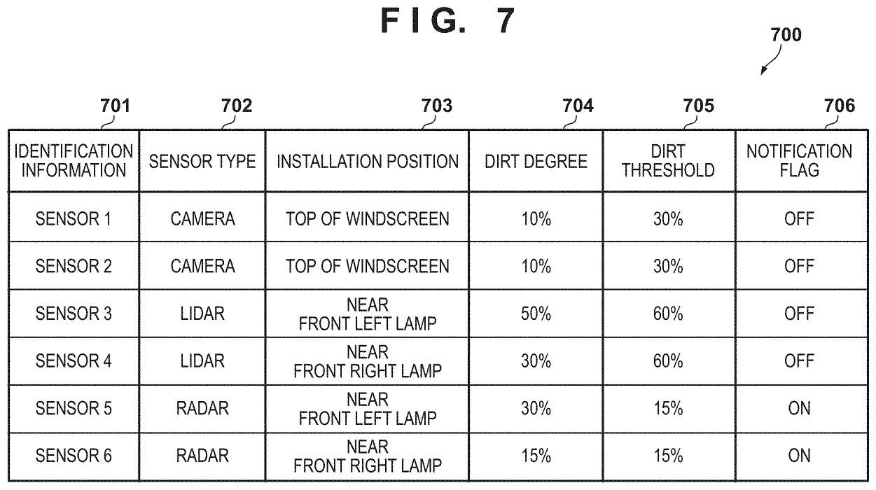

FIG. 7 is a view showing an example of the arrangement of a table that holds information for each sensor according to this embodiment. In a table 700, identification information 701 of a sensor, a type 702 of a sensor, an installation position 703, a dirt degree 704, a dirt threshold 705, and a notification flag 706 are associated with each other. The identification information 701 is information used to uniquely identify a sensor. The type 702 represents the type of the sensor. The installation position 703 represents the installation position of the sensor in the vehicle. The dirt degree 704 represents the degree of dirt of the sensor. Note that as the dirt degree 704, only the latest detection result may be held, or past detection results may be held as a history. As the dirt threshold 705, a threshold of dirt on the sensor is set. For example, a value assumed to affect automated driving is set. The notification flag 706 holds a value to be used in the above-described processes shown in FIGS. 5, 6A, and 6B.

In the table 700 shown above, values other than the dirt degree and the notification flag are fixed values. Note that the arrangement of the table is merely an example, and another information may be included, or the table may be divided into a plurality of tables and managed.

(Example of Notification)

FIG. 8 shows an example of a screen configured to notify an operator to a degree of dirt according to this embodiment. For example, a screen 800 shown in FIG. 8 may be displayed on the periphery of a meter provided in the vehicle or on the screen of a car navigation system.

In FIG. 8, the position of a sensor with a high degree of dirt is indicated by a circle 801. Note that as for the display method, the position may be displayed together with the shape of the vehicle as shown in FIG. 8, or may be represented only by characters. In addition, the history (notification count) of past notifications may be displayed, or a time elapsed from the first dirt detection (without removing the dirt) may be displayed. At this time, the information managed in the table 700 shown in FIG. 7 may be referred to and presented to the operator.

As described above, according to this embodiment, it is possible to determine the dirt degree of a detection means, which affects automated driving, and make a notification in accordance with the situation.

### Second Embodiment

In the above-described embodiment, the timing of the notification concerning dirt of a sensor and the like are not particularly limited. In this embodiment, an arrangement assuming a case in which a traveling route with high possibility of automated driving is set in advance will be described. The arrangement of a vehicle and the like are similar to those in the first embodiment, and a repetitive description thereof will be omitted.

Conventionally, selection and setting of a route to travel are done in advance by a car navigation system or the like. In this embodiment, if a route for which automated driving is assumed is included in route setting, the dirt degree of each sensor is detected, and a notification is made in accordance with the degree.

(Dirt Notification Processing)

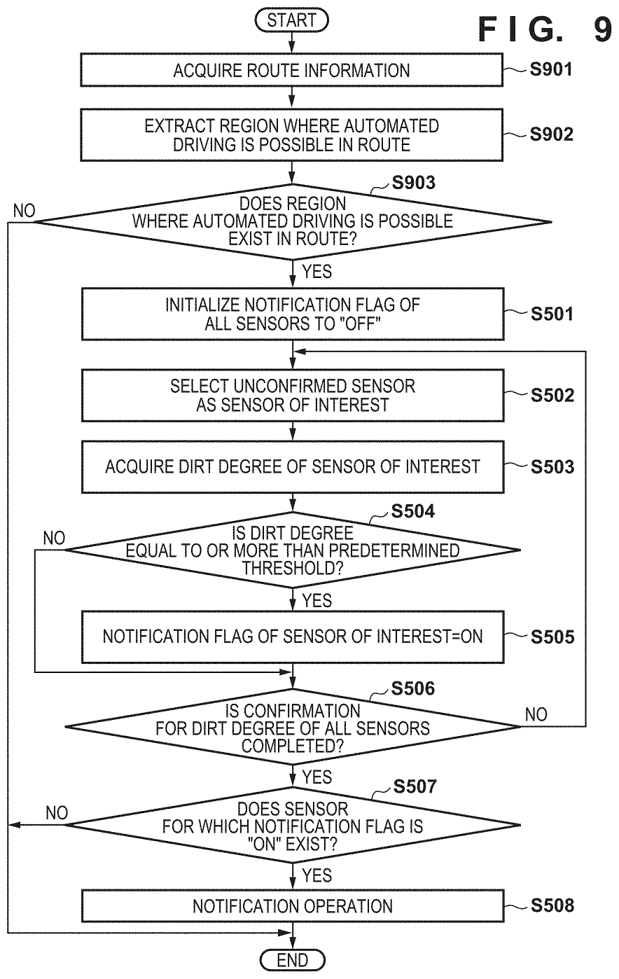

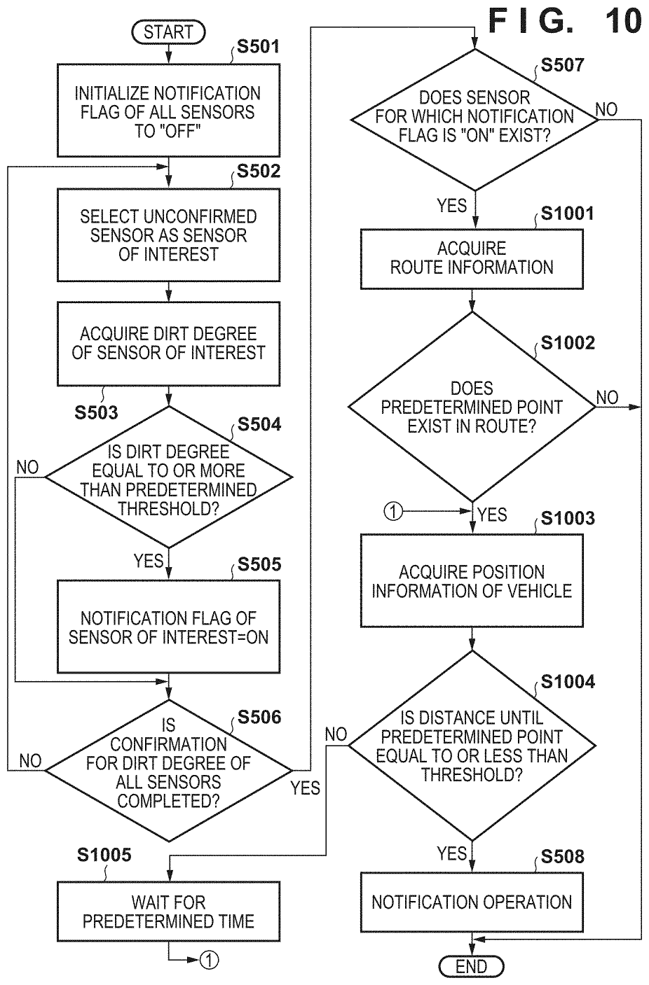

Dirt notification processing according to this embodiment will be described with reference to FIG. 9. Note that the same step numbers as in the dirt notification processing described in the first embodiment with reference to FIG. 5 denote the same processes in FIG. 9.

In step S901, a control apparatus 1 acquires set route information. The route information here includes a current position, a destination, a passing point, a scheduled traveling route, and the like.

In step S902, the control apparatus 1 extracts a region where automated driving is possible from the acquired route information. Here, the region where automated driving is possible is defined in advance as an expressway, a predetermined road, or the like, and can be specified based on position information and the like.

In step S903, the control apparatus 1 determines whether the region where automated driving is possible is included on the traveling route in the process of step S902. If the region where automated driving is possible is included (YES in step S903), the process advances to step S501, and processing similar to the processing described with reference to FIG. 5 is performed from then on. On the other hand, if the region where automated driving is possible is not included (NO in step S903), the processing procedure is ended.

As described above, according to this embodiment, if there is a possibility of automated driving, it is possible to determine the dirt degree and make a notification in accordance with the situation of the dirt. This makes it possible to limit the frequency of dirt notification and control not to perform notifications more than necessary to the user.

### Third Embodiment

In the third embodiment, an embodiment in which at the time of automated driving, dirt detection of a sensor is performed, and a notification is made in accordance with the position of the vehicle will be described.

(Dirt Notification Processing)

Dirt notification processing according to this embodiment will be described with reference to FIG. 10. Note that the same step numbers as in the dirt notification processing described in the first embodiment with reference to FIG. 5 denote the same processes. This processing may be executed at a predetermined time interval. Here, the processing is started in a state in which automated driving is being performed.

If it is determined in the process of step S507 that a sensor for which the value of the notification flag is “ON” exists (YES in step S507), the process advances to step S1001.

In step S1001, a control apparatus 1 acquires route information in the automated driving that is being executed. The route information here includes the information of a destination, a necessary time, a passing point, a traveling route, and the like.

In step S1002, the control apparatus 1 determines whether a predetermined point is to be passed on a route represented by the route information acquired in step S1001. If the route of automated driving is an expressway, the predetermined point here corresponds to, for example, an area such as a service area or a parking area where the operator can take a cleaning action for a sensor. The information about the predetermined point here is defined in advance. If it is determined that the predetermined point exists in the route (YES in step S1002), the process advances to step S1003. If it is determined that the predetermined point does not exist (NO in step S1002), the processing procedure is ended.

In step S1003, the control apparatus 1 acquires position information representing the current position of the vehicle. The position information can be acquired using, for example, a function such as a GPS.

In step S1004, the control apparatus 1 determines whether the distance between the current position and the predetermined point on the route is equal to or less than a threshold. The threshold here is defined in advance. If it is determined that the distance is equal to or less than the threshold (YES in step S1004), the process advances to step S508 to perform a notification operation. If it is determined that the distance is more than the threshold (NO in step S1004), the process advances to step S1005.

In step S1005, the control apparatus 1 waits for a predetermined time. Accordingly, the vehicle approaches the predetermined point by traveling. Information about the predetermined time is defined in advance and held by a storage unit. After that, the process returns to step S1003 to repeat the processing.

As described above, according to this embodiment, it is possible to determine the dirt degree during automated driving and make a notification in accordance with the current position of the vehicle.

Note that the determination is performed based on the distance in step S1004 of FIG. 10. However, the present invention is not limited to this, and, for example, the necessary time until the predetermined point may be used. In addition, the predetermined time used in step S1005 may be changed in accordance with the traveling speed of the vehicle.

Even if the necessary time or distance to the predetermined point is equal to or less than a threshold, if the remaining time or remaining distance until the end of automated driving is less than a predetermined value, control may be performed not to perform the notification operation.

### Fourth Embodiment

In the fourth embodiment, an embodiment in which at the time of automated driving, dirt detection of a sensor is performed, and a notification is made at an appropriate timing while limiting automated driving in accordance with the dirt degree will be described.

(Dirt Notification Processing)

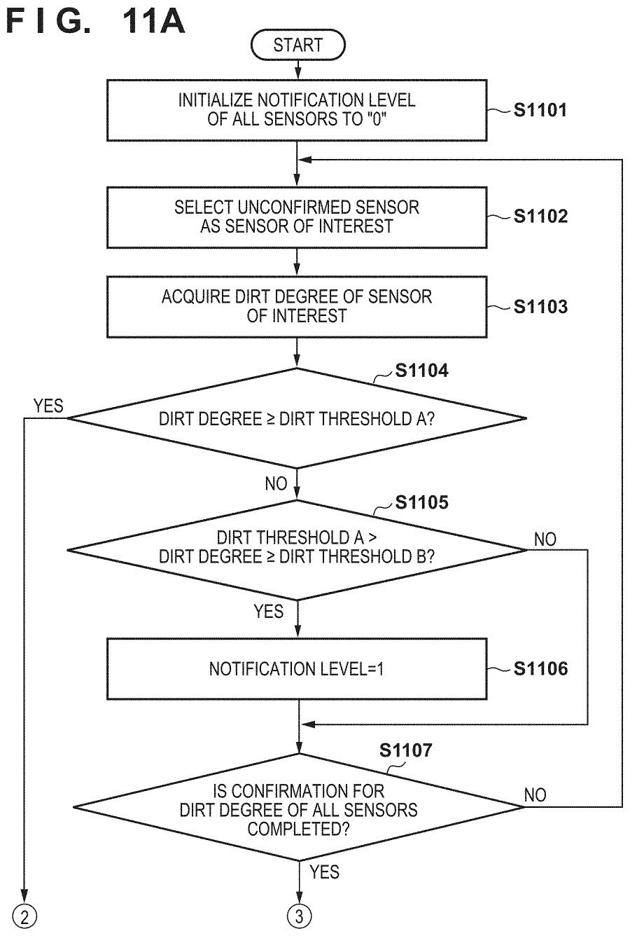

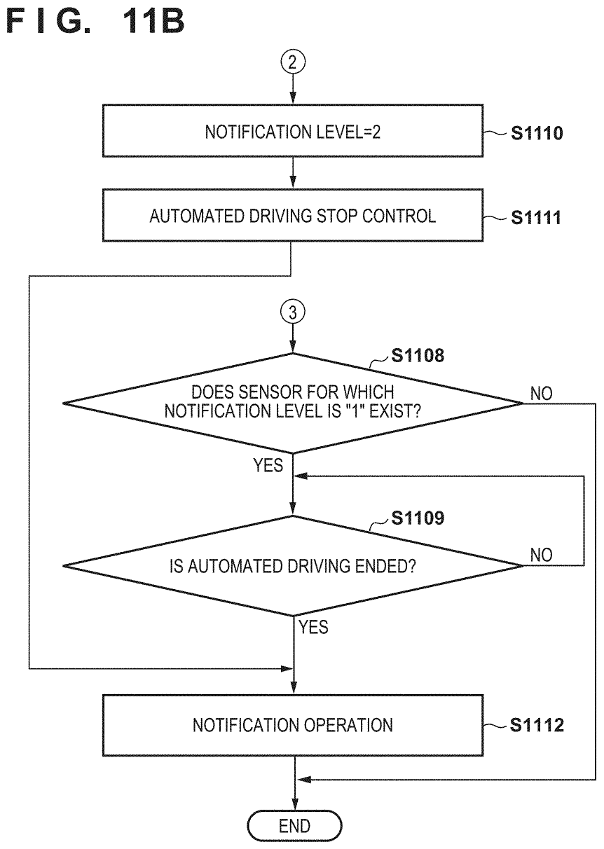

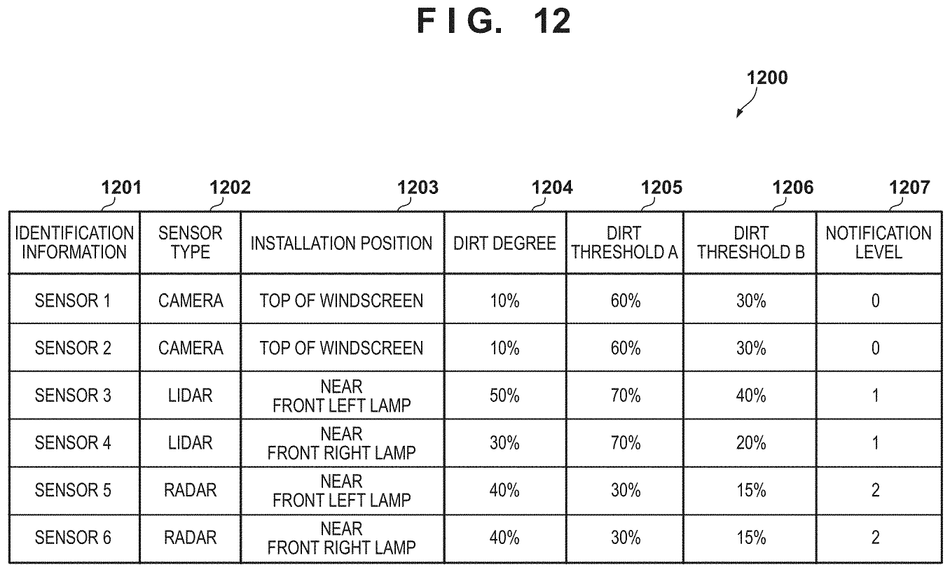

Dirt notification processing according to this embodiment will be described with reference to FIGS. 11A, 11B, and 12.

FIG. 12 shows an example of the arrangement of a table used in this embodiment. In a table 1200, identification information 1201 of a sensor, a type 1202 of a sensor, an installation position 1203, a dirt degree 1204, a dirt threshold A 1205, a dirt threshold B 1206, and a notification level 1207 are associated with each other. The identification information 1201, the type 1202 of the sensor, the installation position 1203, and the dirt degree 1204 are similar to the identification information 701 of the sensor, the type 702 of the sensor, the installation position 703, and the dirt degree 704 in the table 700 shown in the first embodiment. The dirt threshold A 1205 and the dirt threshold B 1206 represent the thresholds of the dirt degree of each sensor. Here, the values are set such that

dirt threshold A>dirt threshold B

is satisfied. The notification level 1207 represents the urgency of the notification of dirt, and values 0 to 2 are set here. In this example, “2” is the highest urgency, and “0” means that a notification concerning dirt is unnecessary. Note that the values other than the dirt degree and the notification level are fixed values. Note that the arrangement of the table is merely an example, and another information may be included, or the table may be divided into a plurality of tables and managed.

Dirt notification processing according to this embodiment will be described next. This processing is started in a state in which automated driving is being performed.

In step S1101, the control apparatus 1 initializes all notification levels corresponding to the plurality of sensors, respectively, provided in the vehicle to “0”. Here, assume that the notification flags corresponding to the sensors are managed in a storage unit. In addition, if the value of a notification level is “0”, it means that dirt on the corresponding sensor is within an allowable range, and a notification concerning the dirt is unnecessary. On the other hand, if the value of a notification level is “1” or “2”, it means that dirt on the corresponding sensor is out of the allowable range, and a notification concerning the dirt and removal of the dirt are necessary.

In step S1102, the control apparatus 1 selects an undetermined sensor of the plurality of sensors as a sensor of interest.

In step S1103, the control apparatus 1 acquires the dirt degree of the sensor of interest. The dirt degree acquisition method is similar to that in the first embodiment and is not particularly limited.

In step S1104, the control apparatus 1 determines whether the dirt degree acquired in step S1103 is equal to or more than the corresponding dirt threshold A. If it is determined that the dirt degree of the sensor of interest is equal to or more than the dirt threshold A (YES in step S1104), the process advances to step S1110. If it is determined that the dirt degree is less than the dirt threshold A (NO in step S1104), the process advances to step S1105.

In step S1105, the control apparatus 1 determines whether the dirt degree acquired in step S1103 is equal to or more than the corresponding dirt threshold B. If it is determined that the dirt degree of the sensor of interest is equal to or more than the dirt threshold B (that is, dirt threshold A>dirt degree dirt threshold B) (YES in step S1105), the process advances to step S1106. If it is determined that the dirt degree is less than the dirt threshold B (NO in step S1105), the process advances to step S1107.

In step S1106, the control apparatus 1 sets the value of the notification level of the sensor of interest to “1”. After that, the process advances to step S1107.

In step S1107, the control apparatus 1 determines whether the dirt degrees of all sensors are confirmed. If the confirmation is completed for all sensors (YES in step S1107), the process advances to step S1108. If an unconfirmed sensor exists (NO in step S1107), the process returns to step S1102 to repeat the processing by setting the unconfirmed sensor to the sensor of interest.

In step S1108, the control apparatus 1 determines whether a sensor for which the value of the notification level is “1” exists among all the sensors. If a sensor for which the value of the notification level is “1” exists (YES in step S1108), the process advances to step S1109. If the value of the notification level is “0” for all the sensors (NO in step S1108), the processing procedure is ended.

In step S1109, the control apparatus 1 determines whether automated driving is ended. This is, for example, a case in which the vehicle reaches a point where it travels by automated driving or a case in which automated driving is ended in accordance with a user instruction. If it is determined that automated driving is ended (YES in step S1109), the process advances to step S1112. If it is determined that automated driving is not ended (NO in step S1109), the processing waits until automated driving is ended.

In step S1110, the control apparatus 1 sets the value of the notification level of the sensor of interest to “2”. After that, the process advances to step S1111.

In step S1111, since the dirt degree of the sensor is high, and the notification level becomes “2”, the control apparatus 1 determines that automated driving is difficult to continue, and performs automated driving stop control. At the same time, the control apparatus 1 performs an operation of notifying the user that automated driving is to be stopped.

In step S1112, the control apparatus 1 makes a notification of dirt removal in accordance with the value of the notification level. The notification method here can be the method described in the first embodiment. The processing procedure is then ended.

In the above-described example, the dirt degrees of the plurality of sensors are individually determined. If the notification level is “2” for at least one dirt degree, automated driving stop control is performed at that point of time. However, even if the dirt degrees of some sensors are high, if another sensor can complement, it is unnecessary to completely stop automated driving and switch to manual driving. For example, control may be performed to lower the level of automated driving to a level that can be handled in the current sensor state.

The automated driving stop control is not limited to lowering (ending) the level of automated driving. For example, control may be performed to prevent the level of automated driving, which is temporarily lowered in accordance with the dirt degree, from rising again. For example, at the time of congestion or the like, if the dirt degree is high, control is performed to inhibit transition to a higher level of automated driving (maintain the level of automated driving at low level). In addition, an example of control of lowering the level of automated driving is transition from automated driving corresponding to hands-off to automated driving corresponding to hands-on. At this time, the notification contents may be changed in accordance with the control contents (for example, the transition contents of the level of automated driving).

In addition, every time a dirt degree is detected, the information may be recorded, and the notification timing may be controlled in accordance with the degree of variation of the dirt degree. For example, even if the notification level is “1”, if the dirt degree is abruptly continuously rising, a notification may be made early. Alternatively, even if the notification level is “2” at a certain determination timing, if the dirt degree temporarily rises, a notification may not be made. In this case, the determination operation may be repeated several times, and the timing of making the notification may be decided. In addition, if the change of the dirt degree is small, it is not assumed that it immediately affects automated driving. Hence, the timing of the notification may be delayed.

Additionally, in the above example, the notification and control of automated driving are performed using two thresholds for one sensor. However, the present invention is not limited to this. For example, more thresholds may be provided, and the timing of the notification of dirt, the notification contents, control of automated driving, and the like may be defined for each threshold. Concerning control of automated driving, for example, if the vehicle can travel at a plurality of levels of automated driving, and the degree of dirt is high, control may be performed to make a transition to a low level (for example, level 2) of automated driving.

### Fifth Embodiment

In the above embodiments, if the dirt degree of a sensor becomes equal to or more than a predetermined threshold, the user is notified of it and requested to remove the dirt.

In this embodiment, an arrangement in which a cleaning means (not shown) for removing dirt of a sensor is provided on the periphery of the sensor will be described. The cleaning means according to this embodiment may be cleaning using a cleaning agent or may be a component such as a wiper.

If the dirt degree of a sensor is equal to or more than a predetermined threshold, the user is notified, and it is confirmed whether to perform cleaning of the sensor by the cleaning component. In the notification operation in step S508 of FIG. 5, if the dirt degree of the sensor is equal to or more than a predetermined threshold, together with the information, whether to execute the cleaning operation by the cleaning means is accepted. As for the acceptance method here, for example, acceptance may be done by a physical switch, or acceptance may be done by pressing a button displayed on a display means such as a touch panel. Hence, the acceptance means for the cleaning instruction is not particularly limited.

Note that the cleaning means may be provided not for all sensors but for some sensors. In addition, a sensor whose degree of contribution (degree of influence) to automated driving is high may preferentially be cleaned.

As described above, according to this embodiment, in addition to the effects of the above-described embodiments, it is possible to reduce the labor of the user when removing dirt.

### Sixth Embodiment

As the six embodiment of the present invention, another arrangement concerning a notification timing will be described. Note that a description of similar components to the above-described embodiments will be omitted.

In this embodiment, in a state in which a detection flag for any of a plurality of sensors provided in a vehicle is “ON”, a notification is made in accordance with the traveling environment of the vehicle or the state of automated driving. For example, assume that in a state in which the detection flag is “ON”, the vehicle is traveling using an ADAS (Advanced Driver Assistance System), or is traveling by automated driving of low level. Such a situation can occur because even if the detection flag for a given sensor is “ON”, the vehicle can travel without any problem in automated driving of low level by complement of other sensors or the like. Assume that the user requests automated driving of higher level in this situation. Here, if the transition to automated driving of higher level is impossible because of the current degree of dirt of the sensor, the user is notified of it.

In addition, levels of automated driving at which the vehicle can travel or cannot travel at the current degree of dirt may be presented, and the level of automated driving of high level to which the vehicle can transition may be notified together.

As a detailed situation of notification, for example, assume that in a case in which a sensor (for example, a front camera) on the front side of the vehicle is dirty (detection flag=ON), the vehicle is traveling by automated driving of level 2 that requires the surroundings monitoring duty. Also assume that transition to level 3 that is more advanced automated driving is impossible. In this situation, if a transition instruction to level 3 is accepted from the user, or the vehicle enters a congestion, a notification concerning the dirt of the sensor is made. Furthermore, the user may be notified that the transition to level 3 is impossible.

As described above, according to this embodiment, in addition to the effects of the above-described embodiments, it is possible to notify the user of the dirt of a sensor at an appropriate timing.

### SUMMARY OF EMBODIMENT

1. A notification system according to the above embodiment is

a notification system (for example, 1) in a vehicle (for example, V) that performs automated driving and includes a plurality of detection units (for example, 31A, 31B, 32A, 32B) for acquiring peripheral information, comprising:

a specifying unit (for example, 2A) configured to specify dirt of each of the plurality of detection units;

an acquisition unit (for example, 2A) configured to acquire information of a scheduled traveling route;

a determination unit (for example, 2A) configured to determine whether a range where automated driving is possible is included in the traveling route; and

a notification unit (for example, 2A) configured to make a notification of information concerning dirt specified for each of the plurality of detection units if it is determined by the determination unit that the range where automated driving is possible is included.

According to this embodiment, it is possible to provide information concerning dirt of the detection means to the user at an appropriate timing while maintaining the accuracy of the detection means needed for automated driving.

2. The notification system according to the above embodiment

further comprises a setting unit (for example, 25A) configured to set the traveling route.

According to this embodiment, it is possible to decide the timing of notification based on a route setting set by the user.

3. A notification system according to the above embodiment is

a notification system (for example, 1) in a vehicle (for example, V) that performs automated driving and includes a plurality of detection units (for example, 31A, 31B, 32A, 32B) configured to acquire peripheral information, comprising:

a specifying unit (for example, 2A) configured to specify dirt of each of the plurality of detection units;

an acquisition unit (for example, 2A) configured to acquire information of a scheduled traveling route; and

a notification unit (for example, 2A) configured to make a notification of information concerning dirt specified for each of the plurality of detection units based on a predetermined point in the traveling route and position information of the vehicle.

According to this embodiment, it is possible to provide information concerning dirt of the detection means to the user at an appropriate timing while maintaining the accuracy of the detection means needed for automated driving.

4. In the notification system according to the above embodiment,

the notification unit makes the notification if a distance between the vehicle and the predetermined point is less than a predetermined threshold.

According to this embodiment, it is possible to decide notification execution propriety in accordance with the distance between the vehicle and the predetermined point.

5. In the notification system according to the above embodiment,

the notification unit makes the notification if a necessary time from a current position of the vehicle to the predetermined point is less than a predetermined threshold.

According to this embodiment, it is possible to decide notification execution propriety in accordance with the necessary time to the predetermined point.

6. A notification system according to the above embodiment is

a notification system (for example, 1) in a vehicle (for example, V) that performs automated driving and includes a plurality of detection units (for example, 31A, 31B, 32A, 32B) configured to acquire peripheral information, comprising:

a specifying unit (for example, 2A) configured to specify dirt of each of the plurality of detection units; and

a notification unit (for example, 2A) configured to make a notification of information concerning dirt specified for each of the plurality of detection units,

wherein the notification unit

ends the automated driving and makes the notification if a degree of the dirt exceeds a first threshold, and

makes the notification when the automated driving is ended if the degree of the dirt is less than the first threshold and more than a second threshold that is smaller than the first threshold.

According to this embodiment, it is possible to provide information concerning dirt of the detection means to the user at an appropriate timing while maintaining the accuracy of the detection means needed for automated driving.

7. In the notification system according to the above embodiment,

the notification unit decides a timing of making the notification in accordance with a change of the degree of the dirt.

According to this embodiment, it is possible to make the notification at an appropriate timing in accordance with a variation of the dirt.

8. In the notification system according to the above embodiment,

the notification unit makes the notification by displaying a screen indicating a position of a detection unit whose dirt should be removed.

According to this embodiment, the user can easily grasp a dirty detection means.

9. In the notification system according to the above embodiment,

the notification unit makes the notification by operating an alarming unit provided on the periphery of the detection units.

According to this embodiment, the user can easily grasp a dirty detection means.

10. A vehicle according to the above embodiment is

a vehicle (for example, V) that performs automated driving, comprising:

a notification system (for example, 2A) of any one of the above embodiments;

a detection unit (for example, 31A, 31B, 32A, 32B);

a cleaning unit for the detection unit;

an acceptance unit configured to accept an instruction of cleaning by the cleaning unit; and

a unit configured to control cleaning of the detection unit by the cleaning unit based on the instruction accepted by the acceptance unit.

According to this embodiment, it is possible to provide information concerning dirt of the detection means to the user at an appropriate timing while maintaining the accuracy of the detection means needed for automated driving, and the user can easily clean the detection means.

11. A vehicle according to the above embodiment is

a vehicle that performs automated driving, comprising:

a notification system of any one of the above embodiments;

a detection unit; and

a control unit configured to make a transition to one of the plurality of levels in accordance with a degree of dirt specified by specifying unit.

According to this embodiment, it is possible to provide information concerning dirt of the detection means to the user at an appropriate timing while maintaining the accuracy of the detection means needed for automated driving, and automated driving can be controlled in accordance with the dirt.

12. A vehicle according to the above embodiment is

a vehicle that supports automated driving of a plurality of levels, comprising:

a notification system of any one of above embodiments; and

a detection unit,

wherein a notification unit makes a notification if, during traveling of the vehicle at a level of automated driving at which the vehicle can travel with a degree of dirt specified by a specifying unit, an instruction of transition to a level of automated driving at which the vehicle cannot travel with the degree of dirt is accepted.

According to this embodiment, it is possible to notify the user of the dirt at an appropriate timing concerning a change of the level of automated driving.

13. A control method according to the above embodiment is

a control method of a notification system in a vehicle that performs automated driving and includes a plurality of detection units configured to acquire peripheral information, comprising:

specifying dirt of each of the plurality of detection units;

acquiring information of a scheduled traveling route;

determining whether a range where automated driving is possible is included in the traveling route; and

making a notification of information concerning dirt specified for each of the plurality of detection units if it is determined in the determining that the range where automated driving is possible is included.

According to this embodiment, it is possible to provide information concerning dirt of the detection means to the user at an appropriate timing while maintaining the accuracy of the detection means needed for automated driving.

14. A control method according to the above embodiment is

a control method of a notification system in a vehicle that performs automated driving and includes a plurality of detection units configured to acquire peripheral information, comprising:

specifying dirt of each of the plurality of detection units;

acquiring information of a scheduled traveling route; and

making a notification of information concerning dirt specified for each of the plurality of detection units based on a predetermined point in the traveling route and position information of the vehicle.

According to this embodiment, it is possible to provide information concerning dirt of the detection means to the user at an appropriate timing while maintaining the accuracy of the detection means needed for automated driving.

15. A control method according to the above embodiment is

a control method of a notification system in a vehicle that performs automated driving and includes a plurality of detection units configured to acquire peripheral information, comprising:

specifying dirt of each of the plurality of detection units; and

making a notification of information concerning dirt specified for each of the plurality of detection units,

wherein,

the automated driving is ended, and the notification is made if a degree of the dirt exceeds a first threshold, and

the notification is made when the automated driving is ended if the degree of the dirt is less than the first threshold and more than a second threshold that is smaller than the first threshold.

According to this embodiment, it is possible to provide information concerning dirt of the detection means to the user at an appropriate timing while maintaining the accuracy of the detection means needed for automated driving.

16. A non-transitory computer-readable medium storing a program according to the above embodiment is

a program configured to cause a computer mounted in a vehicle that performs automated driving and includes a plurality of detection unit configured to acquire peripheral information to function as:

a specifying unit configured to specify dirt of each of the plurality of detection units;

an acquisition unit configured to acquire information of a scheduled traveling route;

a determination unit configured to determine whether a range where automated driving is possible is included in the traveling route; and

a notification unit configured to make a notification of information concerning dirt specified for each of the plurality of detection units if it is determined by the determination unit that the range where automated driving is possible is included.

According to this embodiment, it is possible to provide information concerning dirt of the detection means to the user at an appropriate timing while maintaining the accuracy of the detection means needed for automated driving.

17. A non-transitory computer-readable medium storing a program according to the above embodiment is

a program configured to cause a computer mounted in a vehicle that performs automated driving and includes a plurality of detection units configured to acquire peripheral information to function as:

a specifying unit configured to specify dirt of each of the plurality of detection units;

an acquisition unit configured to acquire information of a scheduled traveling route; and

a notification unit configured to make a notification of information concerning dirt specified for each of the plurality of detection units based on a predetermined point in the traveling route and position information of the vehicle.

According to this embodiment, it is possible to provide information concerning dirt of the detection means to the user at an appropriate timing while maintaining the accuracy of the detection means needed for automated driving.

18. A non-transitory computer-readable medium storing a program according to the above embodiment is

a program configured to cause a computer mounted in a vehicle that performs automated driving and includes a plurality of detection units configured to acquire peripheral information to function as:

a specifying unit configured to specify dirt of each of the plurality of detection units; and

a notification unit configured to make a notification of information concerning dirt specified for each of the plurality of detection units,

wherein the notification unit

ends the automated driving and makes the notification if a degree of the dirt exceeds a first threshold, and

makes the notification when the automated driving is ended if the degree of the dirt is less than the first threshold and more than a second threshold that is smaller than the first threshold.

According to this embodiment, it is possible to provide information concerning dirt of the detection means to the user at an appropriate timing while maintaining the accuracy of the detection means needed for automated driving.

The present invention is not limited to the above embodiments, and various changes and modifications can be made within the spirit and scope of the present invention. Therefore, to apprise the public of the scope of the present invention, the following claims are made.

What is claimed is:

1. A notification system in a vehicle that performs automated driving and includes a plurality of detection unit configured to acquire peripheral information, comprising:
a specifying unit configured to specify dirt of each of the plurality of detection units;
an acquisition unit configured to acquire information of a scheduled traveling route;
a determination unit configured to determine whether a range where automated driving is possible is included in the traveling route; and
a notification unit configured to make a notification of information concerning dirt specified for each of the plurality of detection units if it is determined by the determination unit that the range where automated driving is possible is included.

2. The notification system according to claim 1, further comprising a setting unit configured to set the traveling route.

3. A notification system in a vehicle that performs automated driving and includes a plurality of detection units configured to acquire peripheral information, comprising:
a specifying unit configured to specify dirt of each of the plurality of detection units;
an acquisition unit configured to acquire information of a scheduled traveling route; and
a notification unit configured to make a notification of information concerning dirt specified for each of the plurality of detection units based on a predetermined point in the traveling route and position information of the vehicle.

4. The notification system according to claim 3, wherein the notification unit makes the notification if a distance between the vehicle and the predetermined point is less than a predetermined threshold.

5. The notification system according to claim 3, wherein the notification unit makes the notification if a necessary time from a current position of the vehicle to the predetermined point is less than a predetermined threshold.

6. A notification system in a vehicle that performs automated driving and includes a plurality of detection units configured to acquire peripheral information, comprising:
a specifying unit configured to specify dirt of each of the plurality of detection units; and
a notification unit configured to make a notification of information concerning dirt specified for each of the plurality of detection units,
wherein the notification unit
ends the automated driving and makes the notification if a degree of the dirt exceeds a first threshold, and
makes the notification when the automated driving is ended if the degree of the dirt is less than the first threshold and more than a second threshold that is smaller than the first threshold.

7. The notification system according to claim 1, wherein the notification unit decides a timing of making the notification in accordance with a change of the degree of the dirt.

8. The notification system according to claim 1, wherein the notification unit makes the notification by displaying a screen indicating a position of a detection unit whose dirt should be removed.

9. The notification system according to claim 1, wherein the notification unit makes the notification by operating an alarming unit provided on the periphery of the detection unit.

10. A vehicle that performs automated driving, comprising:
a notification system;
a detection unit;
a cleaning unit for the detection unit;
an acceptance unit configured to accept an instruction of cleaning by the cleaning unit; and
a unit configured to control cleaning of the detection unit by the cleaning unit based on the instruction accepted by the acceptance unit,
wherein the notification unit includes
a specifying unit configured to specify dirt of the detection unit,
an acquisition unit configured to acquire information of a scheduled traveling route,
a determination unit configured to determine whether a range where automated driving is possible is included in the traveling route, and
a notification unit configured to make a notification of information concerning dirt specified for the detection unit if it is determined by the determination unit that the range where automated driving is possible is included.

11. A vehicle that supports automated driving of a plurality of levels, comprising:
a notification system:
a detection unit; and
a control unit configured to make a transition to one of the plurality of levels in accordance with a degree of dirt specified by specifying unit,
wherein the notification unit includes
a specifying unit configured to specify dirt of the detection unit,
an acquisition unit configured to acquire information of a scheduled traveling route,
a determination unit configured to determine whether a range where automated driving is possible is included in the traveling route, and
a notification unit configured to make a notification of information concerning dirt specified for the detection unit if it is determined by the determination unit that the range where automated driving is possible is included.

12. A vehicle that supports automated driving of a plurality of levels, comprising:
a notification system; and
a detection unit,
wherein the notification unit includes
a specifying unit configured to specify dirt of the detection unit,
an acquisition unit configured to acquire information of a scheduled traveling route,
a determination unit configured to determine whether a range where automated driving is possible is included in the traveling route, and
a notification unit configured to make a notification of information concerning dirt specified for the detection unit if it is determined by the determination unit that the range where automated driving is possible is included,
wherein the notification unit makes a notification if, during traveling of the vehicle at a level of automated driving at which the vehicle can travel with a degree of dirt specified by specifying unit, an instruction of transition to a level of automated driving at which the vehicle cannot travel with the degree of dirt is accepted.

13. A control method of a notification system in a vehicle that performs automated driving and includes a plurality of detection units configured to acquire peripheral information, comprising:
specifying dirt of each of the plurality of detection units;
acquiring information of a scheduled traveling route;
determining whether a range where automated driving is possible is included in the traveling route; and
making a notification of information concerning dirt specified for each of the plurality of detection units if it is determined in the determining that the range where automated driving is possible is included.

14. A control method of a notification system in a vehicle that performs automated driving and includes a plurality of detection units configured to acquire peripheral information, comprising:
specifying dirt of each of the plurality of detection units;
acquiring information of a scheduled traveling route; and
making a notification of information concerning dirt specified for each of the plurality of detection units based on a predetermined point in the traveling route and position information of the vehicle.

15. A control method of a notification system in a vehicle that performs automated driving and includes a plurality of detection units configured to acquire peripheral information, comprising:
specifying dirt of each of the plurality of detection units; and
making a notification of information concerning dirt specified for each of the plurality of detection units,
wherein
the automated driving is ended, and the notification is made if a degree of the dirt exceeds a first threshold, and
the notification is made when the automated driving is ended if the degree of the dirt is less than the first threshold and more than a second threshold that is smaller than the first threshold.

16. A non-transitory computer-readable medium storing a program configured to cause a computer mounted in a vehicle that performs automated driving and includes a plurality of detection units configured to acquire peripheral information to function as:
a specifying unit configured to specify dirt of each of the plurality of detection units;
an acquisition unit configured to acquire information of a scheduled traveling route;
a determination unit configured to determine whether a range where automated driving is possible is included in the traveling route; and
a notification unit configured to make a notification of information concerning dirt specified for each of the plurality of detection units if it is determined by the determination unit that the range where automated driving is possible is included.

17. A non-transitory computer-readable medium storing a program configured to cause a computer mounted in a vehicle that performs automated driving and includes a plurality of detection units configured to acquire peripheral information to function as:
a specifying unit configured to specify dirt of each of the plurality of detection units;
an acquisition unit configured to acquire information of a scheduled traveling route; and
a notification unit configured to make a notification of information concerning dirt specified for each of the plurality of detection units based on a predetermined point in the traveling route and position information of the vehicle.

18. A non-transitory computer-readable medium storing a program configured to cause a computer mounted in a vehicle that performs automated driving and includes a plurality of detection units configured to acquire peripheral information to function as:
a specifying unit configured to specify dirt of each of the plurality of detection units; and
a notification unit configured to make a notification of information concerning dirt specified for each of the plurality of detection units,
wherein the notification unit
ends the automated driving and makes the notification if a degree of the dirt exceeds a first threshold, and
makes the notification when the automated driving is ended if the degree of the dirt is less than the first threshold and more than a second threshold that is smaller than the first threshold.
